(19) United States
(12) Patent Application Publication
(10) Pub. No.: US 2025/0160313 A1
(43) Pub. Date: May 22, 2025

(54) PEST CONTROL APPARATUS AND SYSTEM

(71) Applicant: Samantha CLUM, Dallas, TX (US)

(72) Inventor: Samantha CLUM, Dallas, TX (US)

(21) Appl. No.: 18/511,911

(22) Filed: Nov. 16, 2023

(51) Int. Cl. A01M 25/00

(52) U.S. Cl. CPC A01M 25/004

(57) ABSTRACT

A pest control apparatus for housing a pest station. The pest control apparatus comprising a first end wall, a second end wall, a first side wall, a second side wall, and an inner shelf. The first and second side walls interconnect the first and second end walls, forming an internal cavity within the apparatus. The inner shelf is positioned within the internal cavity, forming top and bottom compartments within the internal cavity. At least one of the first and second side walls includes an opening, providing access into the bottom compartment. The pest station may be positioned within the bottom compartment of the apparatus such that openings in the sides of the pest station align with the at least one opening in the pest control apparatus.

### CROSS-REFERENCE TO RELATED APPLICATIONS

Not Applicable.

### BACKGROUND

### Technical Field

The present disclosure relates to pest control apparatuses, systems, and methods of use.

### Description of Related Art

Pests, such as mice and other rodents, carry diseases that spread through direct contact and fecal matter. These pests can also cause structural damage to buildings and objects located therein by chewing through various materials. End users typically employ standard mouse traps to rid an environment of these pests. However, these standard mouse traps can be unsightly and leave a gruesome scene when a rodent is caught. Further, these standard mouse traps are exposed to the environment and may be interfered with by house pets. Therefore, there exists a need for a pest control apparatus that conceals the trap and the pest when caught.

### BRIEF SUMMARY

The present disclosure is directed to a pest control apparatus for housing a pest station. The pest control apparatus comprises a first end wall, a second end wall, a first side wall, and a second side wall. The first and second side walls interconnect the first and second end walls, forming an internal cavity within the apparatus. The pest control apparatus further comprises an inner shelf positioned within the internal cavity. The inner shelf forms a first compartment and a second compartment within the internal cavity, with the first compartment being positioned above the second compartment. At least one of the first and second side walls includes an opening, thereby providing access into the second compartment. The first and second side walls may each have an opening, with the openings defining a first segment and a second segment. The second segment is positioned between the opening and the second end wall, with the second segment being larger than the first segment.

In one aspect, the first end wall extends an entire height of the pest control apparatus, and the second end wall extends less than the entire height of the pest control apparatus. The inner shelf couples to a bottom portion of the second end wall, thereby creating a rear opening into the second compartment, whereby the rear opening provides for installation and removal of the pest station. The pest control apparatus may further comprise a hatch coupled to the bottom portion of the second end wall via a hinge, with the hatch and second end wall extending the entire height of the pest control apparatus. The hatch is configured to open at the hinge, thereby concealing the pest station after installation.

In another aspect, the pest control apparatus may further comprise a top frame, a bottom frame, and a plurality of legs. The top frame includes a first plurality of segments that form a first plurality of corners, and the bottom frame includes a second plurality of segments that form a second plurality of corners. The top frame couples to each top portion of the first and second end walls and the first and second side walls. The bottom frame couples to each bottom portion of the first end wall and the first and second side walls. The plurality of legs interconnect the top frame and the bottom frame at the first and second plurality of corners. The top and bottom frames and the plurality of legs may be fastened together with screws, and the first and second end walls and the first and second side walls snap-fit with at least the top frame and the plurality of legs. Each of the plurality of legs may include a notch positioned a distance from the top frame, wherein inner shelf is installed inside the cavity and supported by the notches of the plurality of legs.

In yet another aspect, the pest control apparatus may further comprise a first side frame, a second side frame, and a plurality of legs. The first side frame includes a plurality of segments that form a perimeter having a first plurality of corners, wherein the first side wall is installed inside of the perimeter of the first side frame. The second side frame includes a plurality of segments that form a perimeter having a second plurality of corners, wherein the second side wall is installed inside of the perimeter of the second side frame. The plurality of legs interconnect the first and second side frames at the first and second plurality of corners, thereby forming a third side frame and a fourth side frame. The third side frame includes a perimeter defined by the plurality of legs interconnecting a first side of the first and second side frames, wherein the first end wall is installed inside of the perimeter of the third side frame. The fourth side frame having a perimeter defined by the plurality of legs interconnecting a second side of the first and second side frames, wherein the second end wall is installed inside of the perimeter of the fourth side frame.

The plurality of segments of the first and second side frames includes two longitudinal segments and two transverse segments. Each of the two longitudinal segments of the first and second side frames have a notch positioned a distance from a top of the first and second side frames. The inner shelf is installed inside the cavity and supported by the notches of the two longitudinal segments of the first and second side frames. The first and second side frames and the plurality of legs are fastened together with screws, and the first and second end walls and the first and second side walls snap-fit with at first and second side frames and the plurality of legs.

In another aspect, at least one of the first and second side walls comprise a protrusion extending from an interior surface of the first and second side walls into the compartment, with the protrusion being positioned along the second segment. The protrusion of the at least one of the first and second side walls is configured to engage the pest station, thereby securing the pest station in place. The second compartment may have a width corresponding to a width of the pest station, whereby the pest station is in flush contact with the first and second side walls.

The present disclosure is also directed to a pest control system for capturing pests. The pest control system comprises an apparatus having a first end wall, a second end wall, a first side wall, a second side wall, and an inner shelf. The first and second side walls interconnect the first and second end walls, forming an internal cavity within the apparatus. The inner shelf is positioned within the internal cavity, thereby forming a first compartment and a second compartment within the internal cavity, with the first compartment being positioned above the second compartment. The first and second side walls each include an opening, providing access into the second compartment. The pest control system further comprises a pest station. The pest station includes a top surface, a bottom surface, and a plurality of lateral surfaces. The plurality of lateral surfaces interconnect the top and bottom surfaces, thereby forming an internal compartment within the pest station. Two opposing side surfaces of the plurality of lateral surfaces include openings into the internal compartment. The pest station is positioned within the second compartment of the apparatus such that the openings in the two opposing side surfaces align with the openings in the first and second side walls of the apparatus.

In one aspect, each opening in the first and second side walls defines a first segment and a second segment, with the first segment being positioned between the opening and the first end wall, and the second segment being positioned between the opening and the second end wall. The second segment may be sized to be larger than the first segment.

In another aspect, the internal compartment of the pest station comprises a bait section and a channel, with the channel extending between both openings of the pest station. The channel includes an opening that provides access from the channel into the bait section. The second compartment of the internal cavity may have a width corresponding to a width of the pest station, whereby the pest station is in flush contact with the first and second side walls.

In yet another aspect, at least one of the plurality of lateral surfaces comprises an engagement interface, and at least one of the first and second side walls comprise a protrusion extending from an interior surface of the first and second side walls into the compartment. The protrusion of the at least one of the first and second side walls is positioned along the second segment and configured to engage the engagement interface of the pest station, thereby securing the pest station in place.

In another aspect, the apparatus further comprises a top frame, a bottom frame, and a plurality of legs. The top frame includes a first plurality of segments that form a first plurality of corners, and the bottom frame includes a second plurality of segments that form a second plurality of corners. The top frame couples to each top portion of the first and second end walls and the first and second side walls, and the bottom frame couples to each bottom portion of the first end wall and the first and second side walls. The plurality of legs interconnect the top frame and the bottom frame at the first and second plurality of corners.

In another aspect, the apparatus further comprising a first side frame, a second side frame, and a plurality of legs. The first side frame includes a plurality of segments that form a perimeter having a first plurality of corners, wherein the first side wall is installed inside of the perimeter of the first side frame. The second side frame includes a plurality of segments that form a perimeter having a second plurality of corners, wherein the second side wall is installed inside of the perimeter of the second side frame. The plurality of legs interconnect the first and second side frames at the first and second plurality of corners, thereby forming a third side frame and a fourth side frame. The third side frame includes a perimeter defined by the plurality of legs interconnecting a first side of the first and second side frames, wherein the first end wall is installed inside of the perimeter of the third side frame. The fourth side frame having a perimeter defined by the plurality of legs interconnecting a second side of the first and second side frames, wherein the second end wall is installed inside of the perimeter of the fourth side frame.

In yet another aspect, the apparatus may further comprise a hatch coupled to the bottom portion of the second end wall via a hinge. The hatch and second end wall extend the entire height of the pest control apparatus. The hatch is configured to open at the hinge, thereby concealing the pest station after installation.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1A depicts a front perspective view of an embodiment of a pest control apparatus for housing a pest station.

FIG. 1B depicts a rear perspective view of the embodiment illustrated in FIG. 1A.

FIG. 1C depicts a side view of the embodiment illustrated in FIG. 1A.

FIG. 1D depicts a cross-section view of the embodiment illustrated in FIG. 1A.

FIG. 2A depicts a front perspective view of an embodiment of a pest apparatus.

FIG. 2B depicts a rear perspective view of the embodiment illustrated in FIG. 2A.

FIG. 2C depicts plan view of the embodiment illustrated in FIG. 2A.

FIG. 3 depicts plan view of an embodiment of a pest control system for capturing pests.

FIG. 4 depicts an exploded view of an embodiment of a pest control apparatus for housing a pest station.

FIG. 5 depicts an exploded view of an alternative embodiment of a pest control apparatus for housing a pest station.

### DETAILED DESCRIPTION

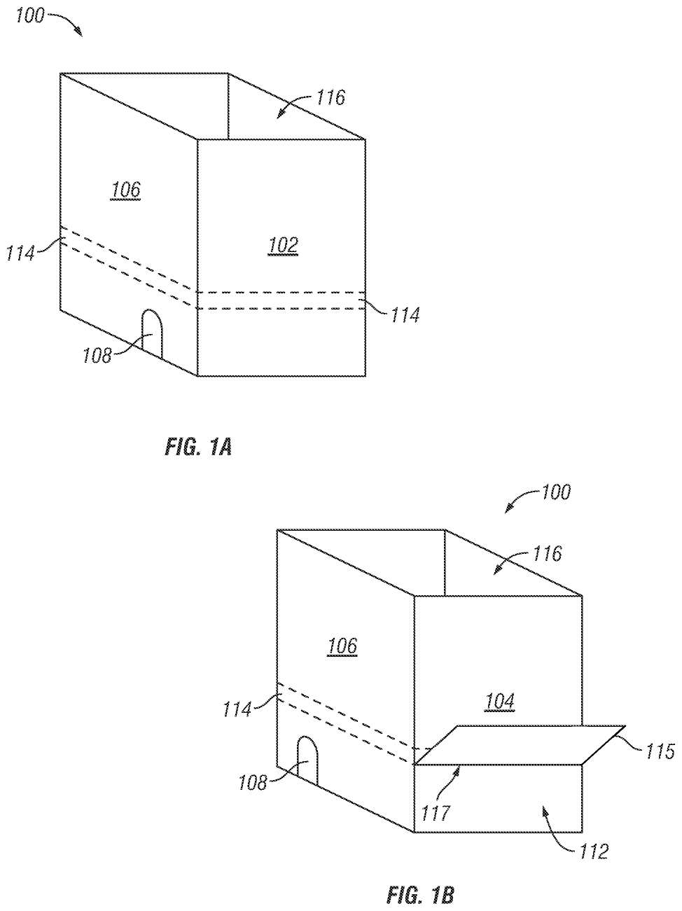

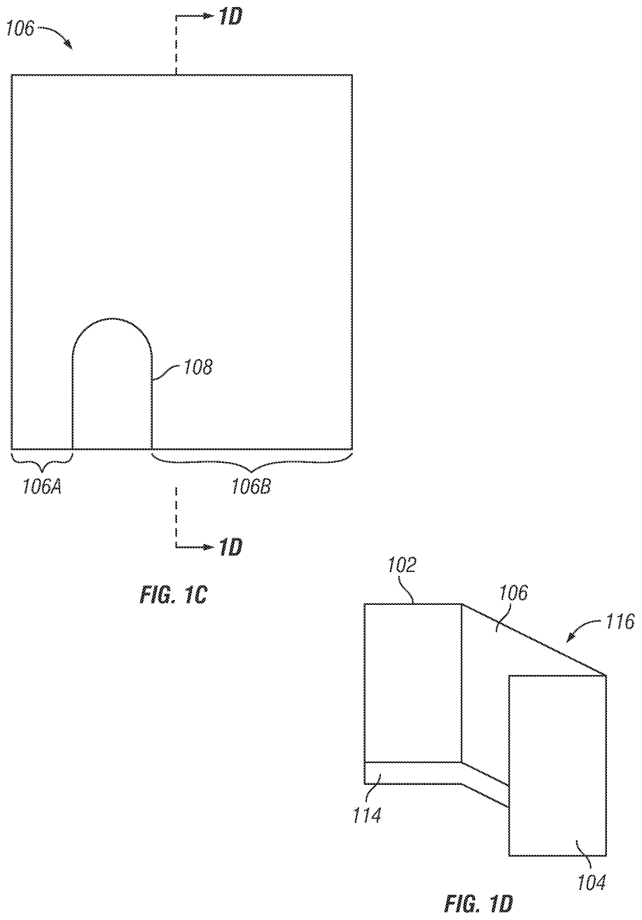

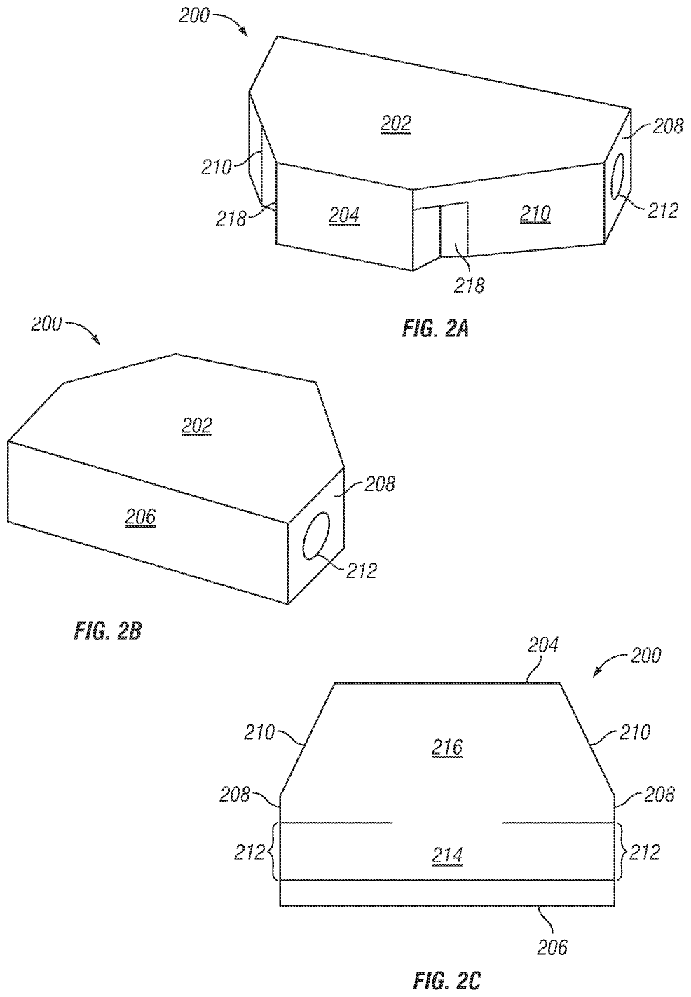

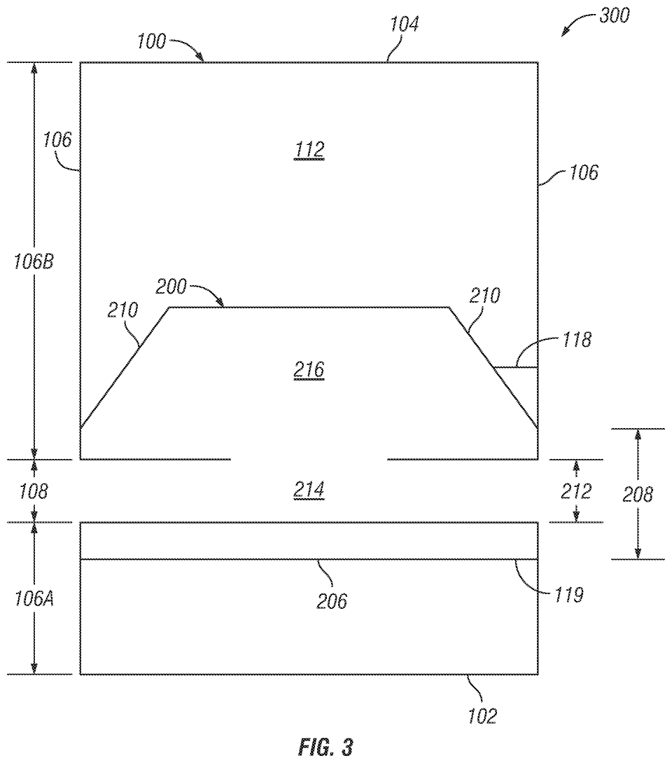

FIGS. 1A-1D depict an embodiment of an apparatus 100 for housing a pest control trap or bait station (see, e.g., FIGS. 2A-2C). The apparatus 100 comprises a first end wall 102, a second end wall 104, a first side wall 106, and a second side wall 106. The first and second side walls 106 interconnect the first and second end walls 102, 104 to form a cavity. As depicted in the illustrative embodiment, the first and second side walls 106 include an opening 108, which enables the pest to access the pest control trap or bait station located within the apparatus 100. Depending on the configuration of the pest control trap or bait station, the openings 108 may be located along the length of the side walls 106. For example, as illustrated in FIG. 1C, the opening 108 may be positioned a first segment 106A away from the first end wall 102 and a second segment 106B away from the second end wall 104. The first segment 106A is positioned between the opening and the first end wall 102, and the second segment 106B is positioned between the opening and the second end wall 104, with the second segment 106B being larger than the first segment 106A. In an alternative embodiment, the apparatus 100 may be configured with only one of the first and second side walls 106 having an opening 108.

The apparatus 100 further comprises an inner shelf 114 positioned within the cavity, forming a first compartment 116 and a second compartment 112. The second compartment 112 provides a rear access to the trap for servicing. The first end wall 102 is sized to extend the height of the pest control apparatus 100. The second end wall 104 is sized to extend less than the entire height of the pest control apparatus 100. The inner shelf 114 couples to the bottom portion of the second end wall 102, creating a rear access opening into the second compartment and providing for servicing of the pest station. Alternatively, the second end wall 104 may be sized to extend the height of the pest control apparatus 100, whereby by the contents in the second compartment may be accessed via lifting the apparatus 100.

In at least one implementation, the apparatus 100 is placed against a barrier (e.g., a wall) with the second wall 104 adjacent to the barrier. The second wall 104 could be placed flush against the barrier or placed within close proximity (e.g., between zero inches and six inches). When the second end wall 104 is sized to extend than the entire height of the pest control apparatus 100 and the end user must service the trap (e.g., discard a captured pest or reload the bait), the end user may access the trap by pulling the apparatus 100 away from the barrier and exposing the trap. Alternatively, the end user may access the trap by lifting the apparatus 100 off the surface.

With reference to FIG. 1B, the apparatus 100 may further comprise a hatch 115 coupled to the bottom portion of the second end wall 104 via a hinge 117, with the hatch 115 and second end wall 104 extending the entire height of the pest control apparatus 100. The hatch 115 is configured to open at the hinge 117, thereby concealing the pest station after installation. The hatch 115 provides the benefit of enclosing the second compartment 116, limiting entry and exit points of the apparatus 100 to the one or more openings 108 in the side walls 106.

FIG. 1D illustrates a cross-sectional view of the first compartment 116. The first compartment 116 is configured to accommodate weight-bearing material, vegetation, or both. Examples of weight-bearing materials include, but are not limited to, rocks, gravel, sand, soil, plant matter, and water. It is advantageous to place weight-bearing material into the first compartment 116 to secure the apparatus 100 in a particular location. For example, without the weight-bearing material, a pest could move the apparatus 100 while accessing the pest control trap or bait station, which would scare the pest away. Additionally, if the apparatus 100 is regularly shifting positions (e.g., from house pets), the pest will likely avoid the apparatus 100. Imitation or real plants may be utilized in the first compartment 116 and may be used to cover any weight-bearing material. The configuration of the apparatus 100 provides the benefit of concealing pest traps while still allowing pests regular access to the baited traps. The apparatus 100 also promotes quick access to the traps for routine servicing or maintenance of the traps.

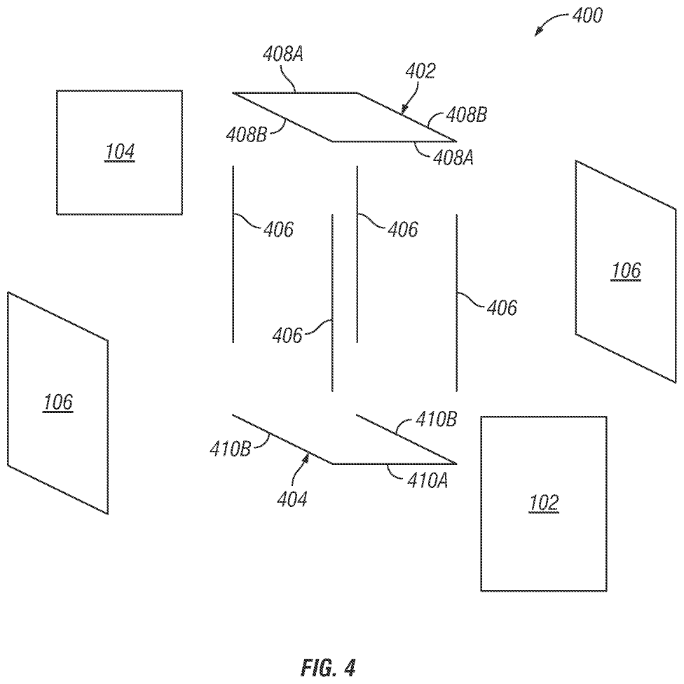

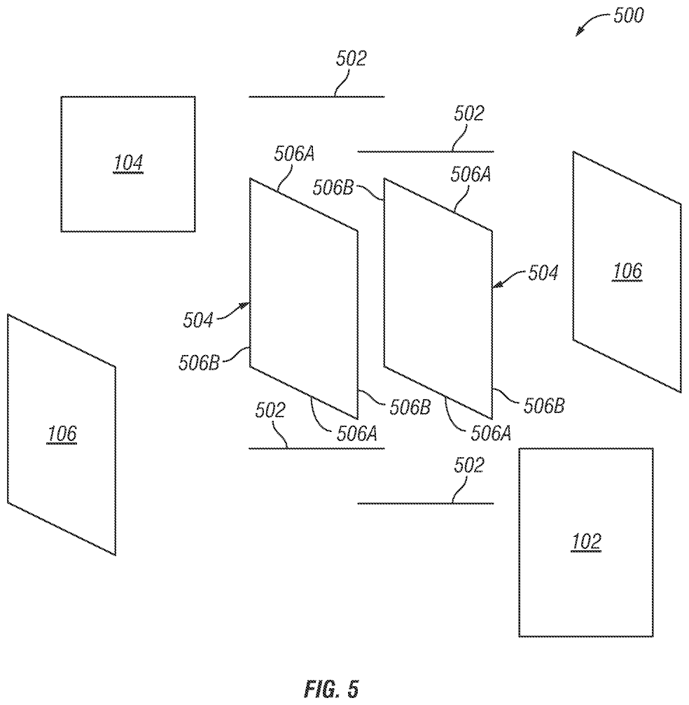

Turning to FIG. 4, an exploded view of an embodiment of an apparatus 400 for housing a pest control trap or bait station is illustrated. The apparatus 400 comprises a first end wall 102, a second end wall 104, and first and second side walls 106. The apparatus 400 further comprises a top frame 402, a bottom frame 404, and a plurality of legs 406. The top frame 402 includes a first plurality of segments 408 that form a first plurality of corners, and the bottom frame 404 includes a second plurality of segments 410 that form a second plurality of corners. The first plurality of segments 408 may include two or more transverse segments 408A and two or more longitudinal segments 408B. The second plurality of segments 410 may include two or more transverse segments 410A and two or more longitudinal segments 410B. The top frame 402 couples to each top portion of the first and second end walls 102, 104 and the first and second side walls 106. The bottom frame 404 couples to each bottom portion of the first end wall 102 and the first and second side walls 106. The plurality of legs 406 interconnect the top frame 402 and the bottom frame 404 at the first and second plurality of corners.

As depicted in FIG. 4, the second plurality of segments 408 of the bottom frame 404 may consist of three segments that form a horseshoe-shape. The horse-shoe-shape of the bottom frame 404 provides an advantage of allowing quick, unhampered access to the trap inside the compartment. For example, the horseshoe-shape of the bottom frame 404 allows an end user to quickly slide a trap in and out of the apparatus 400. The apparatus 400 may be constructed by sliding the first and second end walls 102, 104 and the first and second side walls 106 into the assembled framing (i.e., 404-406). Alternatively, the first and second end walls 102, 104 and the first and second side walls 106 may snap-fit with at least the top frame 402 and the plurality of legs 406. The framing 404-406 is secured by bolts. For example, the framing 404-406 may be secured with hex keys and screws or by other techniques known in the art. The framing 404-406 may by constructed out of aluminum or any other lightweight and rust-resistant material. The walls 102-106 and the internal shelf (not pictured) may be constructed out of plastics (e.g., vinyl) or any other material known in the art that is UV-resistant, lightweight, weatherproof, and/or textured. The walls 102-106 and the internal shelf could include various styles, including faux wood. One or more legs of the plurality of legs 406 may include a notch positioned between the top and bottom frames 402, 404, with the inner shelf being installed inside the cavity and supported by the notches. The framing 402-404 may be used with any embodiment of a pest control trap disclosed herein, including the apparatus 100 depicted in FIGS. 1A-1D.

Referring to FIG. 5, an exploded view of an alternate embodiment of an apparatus 500 for housing a pest control trap or bait station is illustrated. The apparatus 500 comprises a first end wall 102, a second end wall 104, and first and second side walls 106. The apparatus 500 further comprises first and second side frames 504, and a plurality of legs 502. The first and second side frames 504 include a plurality of segments 506 that form a perimeter, creating a first plurality of corners in the first side frame and a second plurality of corners in the second side frame. The plurality of segments 506 may include two or more transverse segments 506A and two or more longitudinal segments 506B. The first and second side walls 106 are installed inside of the perimeters of the first and second side frames 504, respectively. The plurality of legs 502 interconnect the first and second side 504 frames at the first and second plurality of corners, thereby forming a third side frame and a fourth side frame. The third side frame includes a perimeter defined by the plurality of legs 502 interconnecting a first side of the first and second side frames 504. The first end wall 102 is installed inside of the perimeter of the third side frame. The fourth side frame includes a perimeter defined by the plurality of legs 502 interconnecting a second side of the first and second side frames 504. The second end wall is installed inside of the perimeter of the fourth side frame.

The plurality of segments of the first and second side frames 504 includes two longitudinal segments and two transverse segments. Each of the two longitudinal segments of the first and second side frames have a notch positioned between the top and bottom of the first and second side frames 504. The inner shelf (not pictured) is installed inside the cavity and supported by the notches of the two longitudinal segments of the first and second side frames 504. The apparatus 500 may be constructed by sliding the first and second side walls 102, 104 and the first and second side walls 106 into the assembled framing (i.e., 502-504). Alternatively, the first and second end walls 102, 104 and the first and second side walls 106 may snap-fit with at least the top of the framing 502-504. The first and second side frames and the plurality of legs are fastened together by bolts. For example, the framing 502-504 may be secured with hex keys and screws or by other techniques known in the art. The framing 502-504 may be used with any embodiment of a pest control trap disclosed herein, including the apparatus 100 depicted in FIGS. 1A-1D.

The apparatus 100, 400, 500 may be constructed in various sizes according to the needs of an end user. For example, the first end wall 102 and the first and second side walls 106 may have a length of about 19 inches, a width of about 15 inches, and a thickness of about 1 inch. The second end wall 104 may have a length of about 12 inches, a width of about 15 inches, and a thickness of about 1 inch. The inner shelf 114 may have a length of about 15 inches, a width of about 15 inches, and a thickness of about 1 inch. The first compartment 116 may have a length of about 15 inches, a width of about 15 inches, and a depth of about 10 inches. The second compartment 112 may have a length of about 15 inches, a width of about 15 inches, and a depth of about 10 inches. The hatch 115 may have a length of about seven inches, a width of about 15 inches, and a thickness of about 1 inch. The openings 108 in the side walls 106 may have a height of about 2 inches and a width of about two inches. The above dimensions may be modified by larger or smaller within about a fifty percent threshold.

The apparatus 400 may be constructed in various sizes according to the needs of an end user. For example, the transverse segments 408A may have a length of about 17 inches, a width of about 1 inch, and a thickness of about 1 inch. The longitudinal segments 408B may have a length of about 21 inches, a width of about 1 inch, and a thickness of about 1 inch. The plurality of legs 406 may have a length of about 21 inches, a width of about 1 inch, and a thickness of about 1 inch. The above dimensions may be modified by larger or smaller within a fifty percent threshold.

The apparatus 500 may be constructed in various sizes according to the needs of an end user. For example, the transverse segments 506A may have a length of about 17 inches, a width of about 1 inch, and a thickness of about 1 inch. The longitudinal segments 506B may have a length of about 21 inches, a width of about 1 inch, and a thickness of about 1 inch. The plurality of legs 502 may have a length of about 17 inches, a width of about 1 inch, and a thickness of about 1 inch. The above dimensions may be modified by larger or smaller within a fifty percent threshold.

Referring to FIGS. 2A-2C, an embodiment of a pest control trap or bait station (alternatively, pest apparatus) 200 is illustrated. The pest apparatus 200 comprises a top and bottom surface 202, and a plurality of surfaces. As depicted in FIGS. 2A-2C, the plurality of surfaces may include a first lateral surface 204, a second lateral surface 206, a third lateral surface 208, a fourth lateral surface 208, a fifth lateral surface 210, and a sixth lateral surface 210. The number of lateral surfaces may include more or fewer surfaces. One or more of the plurality of surfaces may include an engagement interface 218. The plurality of lateral surfaces 204-210 interconnect the top and bottom surfaces 202, 204, thereby forming an internal compartment within the pest station. Two opposing side surfaces 208 of the plurality of lateral surfaces each include openings 212 into the internal compartment. The internal compartment of the pest station 200 comprises a bait section 216 and a channel 214. The bait section 216 is used to house the bait and trap for the pest. The channel 214 extends between both openings 212 of the pest station 200. The channel 214 includes an opening that provides access from the channel 214 into the bait section 216.

Turning to FIG. 3, a plan view of an embodiment of a pest control system 300 is illustrated. The pest control system 300 comprises the apparatus 100 depicted and described in FIGS. 1A-1D, and the pest apparatus 200 depicted and described in FIGS. 2A-2C. At least one of the first and second side walls 106 comprise a protrusion 118 extending from an interior surface of the first and second side walls 106 into the second compartment 112 of the apparatus 100. In some configurations, each side wall 106 may comprise a protrusion 118. The protrusion 118 is positioned along the second segment 106B. The protrusion 118 is configured to engage the engagement interface 218 of the pest apparatus 200, thereby securing the pest apparatus 200 in place in the second compartment 112. The second compartment 112 may have a width corresponding to the width of the pest apparatus 200, with the pest apparatus 200 being flush with the first and second side walls 106. It is advantageous to size the pest control system 300 such that the apparatus 100 and the pest apparatus 200 are in flush contact to minimize openings into the second compartment. For example, if there are gaps between the apparatus 100 and the pest apparatus 200, a pest could access the second compartment 112 and avoid being caught in the pest apparatus 200.

With continued reference to FIG. 3, the pest station 200 is positioned within the second compartment 112 of the apparatus 100 such that the openings 212 in the two opposing side surfaces 208 align with the openings 108 in the first and second side walls 106 of the apparatus 100. In one embodiment, the pest station 200 and the apparatus 100 are sized such that when the pest station 200 is completely inserted into the second compartment 112 (i.e., the second lateral surface 206 engages the first end wall 102), and the two opposing side surfaces 208 align with the openings 108 in the first and second side walls 106 of the apparatus 100. To enhance the security of the pest station 200, the protrusion 118 extending from the interior of the side wall 106 engages the engagement interface (not pictured) of a lateral surface 210 of the pest station 200. It is advantageous to utilize one or more engagement interface because the one or more protrusions 118 hold the pest station 200 against the first end wall 102, preventing the pest station 200 from shifting positions. In another embodiment, the pest station 200 is inserted into the second compartment 112 of the apparatus 100, and the second lateral surface 206 engages a second protrusion 119 extending from the interior of the side wall 106. Additionally, the first protrusion 118 extending from the interior of the side wall 106 engages the engagement interface (not pictured) of the lateral surface 210 of the pest station 200. In each embodiment, the openings 212 in the two opposing side surfaces 208 align with the openings 108 in the first and second side walls 106 of the apparatus 100. The first and/or second protrusions 118, 119 may be spring-loaded into the second compartment such that the protrusions 118, 119 can be retracted to allow the pest station 200 to be inserted into the second compartment of the apparatus 100. Once the pest station 200 is inserted, the protrusions 118, 119 can be released to engage the pest station 200. Alternatively, the protrusions 118, 119 may be configured to bend as the pest station 200 is pressed or pulled into the second compartment, straightening out when the first protrusion engages the engagement interface. Once the pest station 200 is properly positioned within the second compartment 112 of the apparatus 100, the pest can enter the openings 212 of the pest station 200, travel through the channel 214 and engage the trap in the bait section 216.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that particular technology is prior art to any embodiment(s) in this disclosure. Neither is the “Summary” a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. A pest control apparatus for housing a pest station, the pest control apparatus comprising:
a first end wall and a second end wall;
a first side wall and a second side wall, wherein:
the first and second side walls interconnect the first and second end walls,
the first and second end walls and the first and second side walls form an internal cavity, and
at least one of the first and second side walls includes an opening; and
an inner shelf positioned within the internal cavity, wherein:
the inner shelf forms a first compartment and a second compartment within the internal cavity, with the first compartment being positioned above the second compartment, and
the opening provides access into the second compartment.

2. The pest control apparatus of claim 1, wherein:
the first end wall extends an entire height of the pest control apparatus;
the second end wall extends less than the entire height of the pest control apparatus; and
the inner shelf couples to a bottom portion of the second end wall, thereby creating a rear opening into the second compartment, whereby the rear opening provides for installation and removal of the pest station.

3. The pest control apparatus of claim 2, further comprising a hatch, wherein:
the hatch is coupled to the bottom portion of the second end wall via a hinge, with the hatch and second end wall extending the entire height of the pest control apparatus; and
the hatch is configured to open at the hinge, thereby concealing the pest station after installation.

4. The pest control apparatus of claim 1, further comprising a top frame, a bottom frame, and a plurality of legs, wherein:
the top frame includes a first plurality of segments that form a first plurality of corners;
the bottom frame includes a second plurality of segments that form a second plurality of corners;
the top frame couples to each top portion of the first and second end walls and the first and second side walls;
the bottom frame couples to each bottom portion of the first end wall and the first and second side walls; and
the plurality of legs interconnect the top frame and the bottom frame at the first and second plurality of corners.

5. The pest control apparatus of claim 4, wherein:
each of the plurality of legs have a notch positioned a distance from the top frame; and
the inner shelf is installed inside the cavity and supported by the notches of the plurality of legs.

6. The pest control apparatus of claim 4, wherein:
the top and bottom frames and the plurality of legs are fastened together with screws; and
the first and second end walls and the first and second side walls snap-fit with at least the top frame and the plurality of legs.

7. The pest control apparatus of claim 1, further comprising a first side frame, a second side frame, and a plurality of legs, wherein:
the first side frame includes a plurality of segments that form a perimeter having a first plurality of corners, and wherein the first side wall is installed inside of the perimeter of the first side frame;
the second side frame includes a plurality of segments that form a perimeter having a second plurality of corners, and wherein the second side wall is installed inside of the perimeter of the second side frame;
the plurality of legs interconnect the first and second side frames at the first and second plurality of corners, thereby forming a third side frame and a fourth side frame;
the third side frame includes a perimeter defined by the plurality of legs interconnecting a first side of the first and second side frames, and wherein the first end wall is installed inside of the perimeter of the third side frame; and
the fourth side frame having a perimeter defined by the plurality of legs interconnecting a second side of the first and second side frames, and wherein the second end wall is installed inside of the perimeter of the fourth side frame.

8. The pest control apparatus of claim 7, wherein:
the plurality of segments of the first and second side frames includes two longitudinal segments and two transverse segments;
each of the two longitudinal segments of the first and second side frames have a notch positioned a distance from a top of the first and second side frames; and
the inner shelf is installed inside the cavity and supported by the notches of the two longitudinal segments of the first and second side frames.

9. The pest control apparatus of claim 7, wherein:
the first and second side frames and the plurality of legs are fastened together with screws; and
the first and second end walls and the first and second side walls snap-fit with at first and second side frames and the plurality of legs.

10. The pest control apparatus of claim 1, wherein:
the first and second side walls each comprise an opening, and
each opening defines a first segment and a second segment,
the first segment positioned between the opening and the first end wall, and
the second segment is positioned between the opening and the second end wall, the second segment is larger than the first segment.

11. The pest control apparatus of claim 10, wherein:
at least one of the first and second side walls comprise a protrusion extending from an interior surface of the first and second side walls into the compartment,
the protrusion of the at least one of the first and second side walls being positioned along the second segment, and
the protrusion of the at least one of the first and second side walls is configured to engage the pest station, thereby securing the pest station in place.

12. The pest control apparatus of claim 11, wherein the second compartment has a width corresponding to a width of the pest station, whereby the pest station is in flush contact with the first and second side walls.

13. The pest control apparatus of claim 12, wherein the first and second side walls each comprise a protrusion.

14. A pest control system for capturing pests, the pest control system comprising:
an apparatus comprising a first end wall, a second end wall, a first side wall, a second side wall, and an inner shelf, wherein:
the first and second side walls interconnect the first and second end walls,
the first and second end walls and the first and second side walls form an internal cavity, and
the first and second side walls each include an opening,
the inner shelf is positioned within the internal cavity, thereby forming a first compartment and a second compartment within the internal cavity, with the first compartment being positioned above the second compartment, and
the openings in the first and second side walls provide access into the second compartment; and
a pest station comprising a top surface, a bottom surface, and a plurality if lateral surfaces, wherein:
the plurality of lateral surfaces interconnect the top and bottom surfaces, thereby forming an internal compartment,
two opposing side surfaces of the plurality of lateral surfaces include openings into the internal compartment, and
the pest station is positioned within the second compartment such that the openings in the two opposing side surfaces align with the openings in the first and second side walls of the apparatus.

15. The pest control system of claim 14, wherein:
each opening in the first and second side walls defines a first segment and a second segment,
the first segment is positioned between the opening and the first end wall,
the second segment is positioned between the opening and the second end wall, with the second segment being larger than the first segment.

16. The pest control system of claim 15, wherein:
the internal compartment of the pest station comprises a bait section and a channel,
the channel extends between both openings of the pest station,
the channel includes an opening, whereby the opening provides access from the channel into the bait section, and
the second compartment of the internal cavity has a width corresponding to a width of the pest station, whereby the pest station is in flush contact with the first and second side walls.

17. The pest control system of claim 15, wherein:
at least one of the plurality of lateral surfaces comprises an engagement interface,
at least one of the first and second side walls comprise a protrusion extending from an interior surface of the first and second side walls into the compartment,
the protrusion of the at least one of the first and second side walls being positioned along the second segment, and
the protrusion of the at least one of the first and second side walls is configured to engage the engagement interface of the pest station, thereby securing the pest station in place.

18. The pest control system of claim 15, the apparatus further comprising a top frame, a bottom frame, and a plurality of legs, wherein:
the top frame includes a first plurality of segments that form a first plurality of corners,
the bottom frame includes a second plurality of segments that form a second plurality of corners,
the top frame couples to each top portion of the first and second end walls and the first and second side walls,
the bottom frame couples to each bottom portion of the first end wall and the first and second side walls, and
the plurality of legs interconnect the top frame and the bottom frame at the first and second plurality of corners.

19. The pest control system of claim 15, the apparatus further comprising a first side frame, a second side frame, and a plurality of legs, wherein:
the first side frame includes a plurality of segments that form a perimeter having a first plurality of corners, and wherein the first side wall is installed inside of the perimeter of the first side frame;
the second side frame includes a plurality of segments that form a perimeter having a second plurality of corners, and wherein the second side wall is installed inside of the perimeter of the second side frame;
the plurality of legs interconnect the first and second side frames at the first and second plurality of corners, thereby forming a third side frame and a fourth side frame;
the third side frame includes a perimeter defined by the plurality of legs interconnecting a first side of the first and second side frames, and wherein the first end wall is installed inside of the perimeter of the third side frame; and
the fourth side frame having a perimeter defined by the plurality of legs interconnecting a second side of the first and second side frames, and wherein the second end wall is installed inside of the perimeter of the fourth side frame.

20. The pest control system of claim 15, the apparatus further comprising a hatch, wherein:
the hatch is coupled to the bottom portion of the second end wall via a hinge, with the hatch and second end wall extending the entire height of the pest control apparatus; and
the hatch is configured to open at the hinge, thereby concealing the pest station after installation.
